(19) United States
(12) Patent Application Publication
(10) Pub. No.: US 2018/0046350 A1
(43) Pub. Date: Feb. 15, 2018

(54) SYSTEM AND METHOD FOR DATA CAPTURE, STORAGE, AND RETRIEVAL

(71) Applicant: QUALCOMM Incorporated, San Diego, CA (US)

(72) Inventors: Eric Liu, Sunnyvale, CA (US); Nathaniel Wolf, San Francisco, CA (US); Yoon Kean Wong, Menlo Park, CA (US); Junius K. Ho, Mountain View, CA (US)

(21) Appl. No.: 15/726,923

(22) Filed: Oct. 6, 2017

Related U.S. Application Data
(62) Division of application No. 12/732,077, filed on Mar. 25, 2010.

(51) Int. Cl. G06F 3/0488; H04M 1/725; H04N 5/232; G01S 5/02

(52) U.S. Cl. CPC G06F 3/0488; H04N 5/23206; G01S 5/02; H04M 1/72555

(57) ABSTRACT

A computing device includes a display and a processing circuit coupled to the display. The processing circuit is configured to provide an image on the display, receive an input from a user identifying at least a portion of the image; and automatically transmit the image to a mobile computing device based at least in part on receiving the input.

### CROSS-REFERENCE TO RELATED APPLICATIONS

This application is a divisional of co-pending, commonly assigned, patent application Ser. No. 12/732,077 entitled, “SYSTEM AND METHOD FOR DATA CAPTURE, STORAGE, AND RETRIEVAL”, filed on Mar. 25, 2010, the disclosure of which is hereby incorporated herein by reference.

### BACKGROUND

Electronic devices such as desktop computers, laptop computers, and various other types of computing devices provide information to users. The present disclosure relates generally to the field of such electronic devices, and more specifically, to electronic devices that may facilitate the capture, retrieval, and use of mobile access information and/or other data.

### BRIEF DESCRIPTION OF THE DRAWINGS

FIG. 1 is a perspective view of a mobile computing device according to an exemplary embodiment.

FIG. 2 is a front view of the mobile computing device of FIG. 1 in an extended configuration according to an exemplary embodiment.

FIG. 3 is a back view of the mobile computing device of FIG. 1 in an extended configuration according to an exemplary embodiment.

FIG. 4 is a side view of the mobile computing device of FIG. 1 in an extended configuration according to an exemplary embodiment.

FIG. 5 is a block diagram of the mobile computing device of FIG. 1 according to an exemplary embodiment.

FIG. 6 is a block diagram of a computer network according to an exemplary embodiment.

FIG. 7 is a block diagram of a method of capturing and storing data according to an exemplary embodiment.

FIG. 8 is a block diagram of a method of storing and retrieving data according to another exemplary embodiment.

FIG. 9 is a schematic representation of a display of various types of data according to an exemplary embodiment.

FIG. 10 is a schematic representation of a display of a plurality of image files according to an exemplary embodiment.

FIG. 11 is a schematic representation of a display of a map image according to an exemplary embodiment.

FIG. 12 is a block diagram of a method of capturing images according to an exemplary embodiment.

FIG. 13 is a block diagram of a method of capturing images according to another exemplary embodiment.

FIG. 14 is a block diagram of a method of capturing images according to another exemplary embodiment.

FIG. 15 is a front view of the mobile computing device of FIG. 1 and an image capture aid according to an exemplary embodiment.

### DETAILED DESCRIPTION OF EXEMPLARY EMBODIMENTS

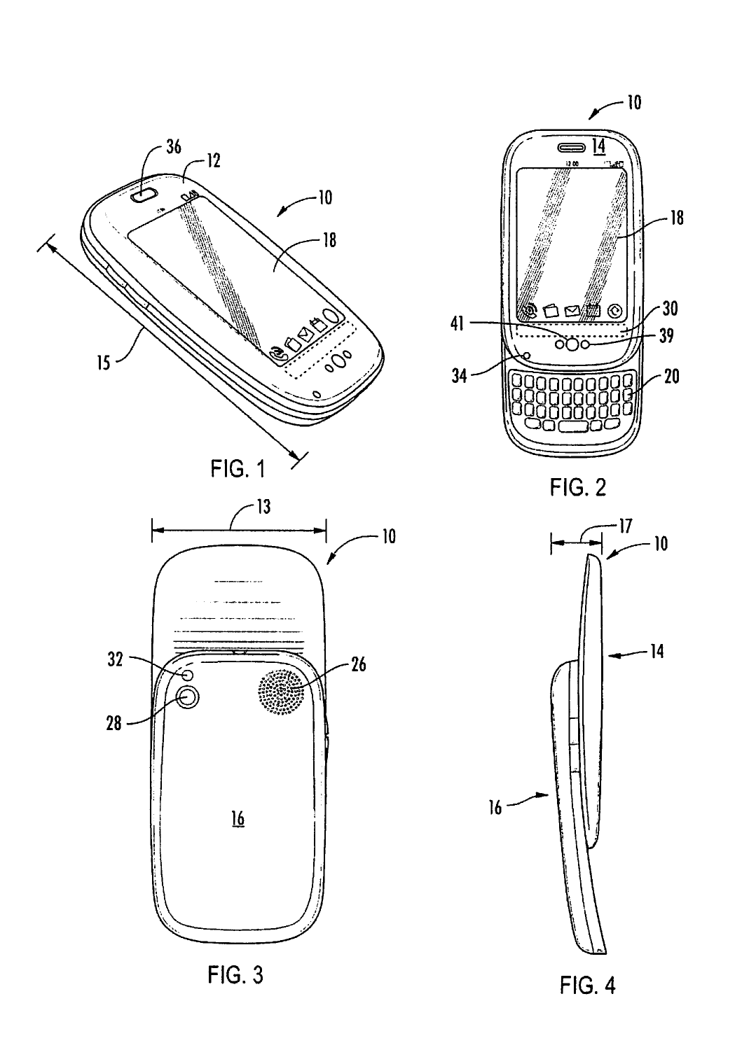

Referring to FIGS. 1-4, a mobile device 10 is shown. The teachings herein can be applied to device 10 or to other electronic devices (e.g., a desktop computer), mobile computing devices (e.g., a laptop computer) or handheld computing devices, such as a personal digital assistant (PDA), smartphone, mobile telephone, personal navigation device, etc. According to one embodiment, device 10 may be a smartphone, which is a combination mobile telephone and handheld computer having PDA functionality. PDA functionality can comprise one or more of personal information management (e.g., including personal data applications such as email, calendar, contacts, etc.), database functions, word processing, spreadsheets, voice memo recording, Global Positioning System (GPS) functionality, etc. Device 10 may be configured to synchronize personal information from these applications with a computer (e.g., a desktop, laptop, server, etc.). Device 10 may be further configured to receive and operate additional applications provided to device 10 after manufacture, e.g., via wired or wireless download, SecureDigital card, etc.

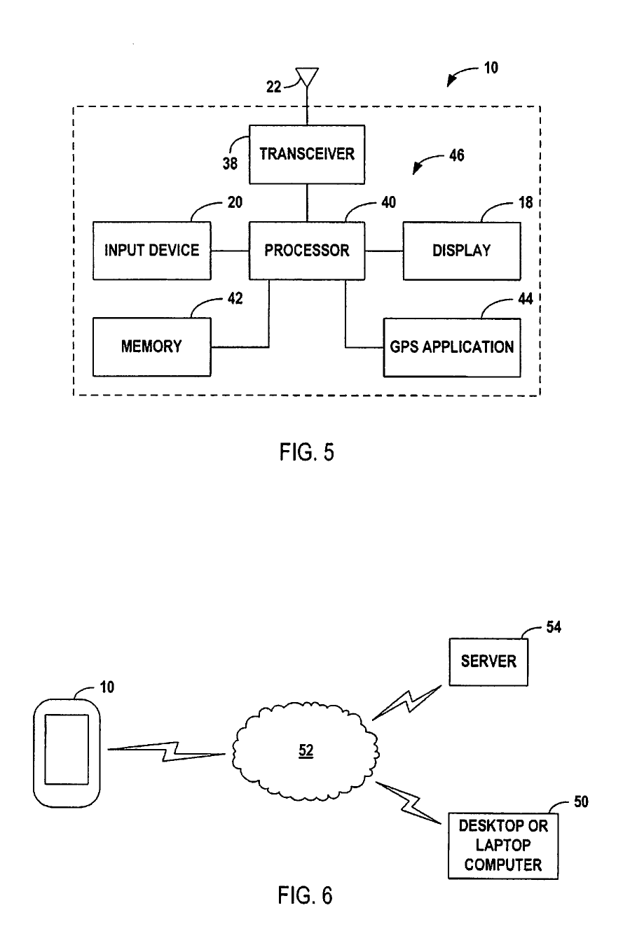

As shown in FIGS. 1-4, device 10 includes a housing 12 and a front 14 and a back 16. Device 10 further comprises a display 18 and a user input device 20 (e.g., an alphanumeric or QWERTY keyboard, buttons, touch screen, speech recognition engine, etc.). Display 18 may comprise a touch screen display in order to provide user input to a processing circuit 46 (see FIG. 5) to control functions, such as to select options displayed on display 18, enter text input to device 10, or enter other types of input. Display 18 also provides images (see, e.g., FIG. 8) that are displayed and may be viewed by users of device 10. User input device 20 can provide similar inputs as those of touch screen display 18. An input button 41 may be provided on front 14 and may be configured to perform pre-programmed functions. Device 10 can further comprise a speaker 26, a stylus (not shown) to assist the user in making selections on display 18, a camera 28, a camera flash 32, a microphone 34, and an earpiece 36.

Display 18 may comprise a capacitive touch screen, a mutual capacitance touch screen, a self capacitance touch screen, a resistive touch screen, a touch screen using cameras and light such as a surface multi-touch screen, proximity sensors, or other touch screen technologies, and so on. Display 18 may be configured to receive inputs from finger touches at a plurality of locations on display 18 at the same time. Display 18 may be configured to receive a finger swipe or other directional input, which may be interpreted by a processing circuit to control certain functions distinct from a single touch input. Further, a gesture area 30 may be provided adjacent to (e.g., below, above, to a side, etc.) or be incorporated into display 18 to receive various gestures as inputs, including taps, swipes, drags, flips, pinches, and so on. One or more indicator areas 39 (e.g., lights, etc.) may be provided to indicate that a gesture has been received from a user.

According to an exemplary embodiment, housing 12 is configured to hold a screen such as display 18 in a fixed relationship above a user input device such as user input device 20 in a substantially parallel or same plane. This fixed relationship excludes a hinged or movable relationship between the screen and the user input device (e.g., a plurality of keys) in the fixed embodiment.

Device 10 may be a handheld computer, which is a computer small enough to be carried in a hand of a user, comprising such devices as typical mobile telephones and personal digital assistants, but excluding typical laptop computers and tablet PCs. The various input devices and other components of device 10 as described below may be positioned anywhere on device 10 (e.g., the front surface shown in FIG. 2, the rear surface shown in FIG. 3, the side surfaces as shown in FIG. 4, etc.). Furthermore, various components such as a keyboard etc. may be retractable to slide in and out from a portion of device 10 to be revealed along any of the sides of device 10, etc. For example, as shown in FIGS. 2-4, front 14 may be slidably adjustable relative to back 16 to reveal input device 20, such that in a retracted configuration (see FIG. 1) input device 20 is not visible, and in an extended configuration (see FIGS. 2-4) input device 20 is visible.

According to various exemplary embodiments, housing 12 may be any size, shape, and have a variety of length, width, thickness, and volume dimensions. For example, width 13 may be no more than about 200 millimeters (mm), 100 mm, 85 mm, or 65 mm, or alternatively, at least about 30 mm, 50 mm, or 55 mm. Length 15 may be no more than about 200 mm, 150 mm, 135 mm, or 125 mm, or alternatively, at least about 70 mm or 100 mm. Thickness 17 may be no more than about 150 mm, 50 mm, 25 mm, or 15 mm, or alternatively, at least about 10 mm, 15 mm, or 50 mm. The volume of housing 12 may be no more than about 2500 cubic centimeters (cc) or 1500 cc, or alternatively, at least about 1000 cc or 600 cc.

Device 10 may provide voice communications functionality in accordance with different types of cellular radiotelephone systems. Examples of cellular radiotelephone systems may include Code Division Multiple Access (CDMA) cellular radiotelephone communication systems, Global System for Mobile Communications (GSM) cellular radiotelephone systems, third generation (3G) systems such as Wide-Band CDMA (WCDMA), or other cellular radio telephone technologies, etc.

In addition to voice communications functionality, device 10 may be configured to provide data communications functionality in accordance with different types of cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Long Term Evolution (LTE) systems, etc.

Device 10 may be configured to provide voice and/or data communications functionality in accordance with different types of wireless network systems. Examples of wireless network systems may further include a wireless local area network (WLAN) system, wireless metropolitan area network (WMAN) system, wireless wide area network (WWAN) system, and so forth. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and so forth.

Device 10 may be configured to perform data communications in accordance with different types of shorter range wireless systems, such as a wireless personal area network (PAN) system. One example of a suitable wireless PAN system offering data communication services may include a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth.

Referring now to FIG. 5, device 10 comprises a processing circuit 46 comprising a processor 40. Processor 40 can comprise one or more microprocessors, microcontrollers, and other analog and/or digital circuit components configured to perform the functions described herein. Processor 40 comprises or is coupled to one or more memories such as memory 42 (e.g., random access memory, read only memory, flash, etc.) configured to store software applications provided during manufacture or subsequent to manufacture by the user or by a distributor of device 10.

In various embodiments, memory 42 may be configured to store one or more software programs to be executed by processor 40. Memory 42 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), or any other type of media suitable for storing information.

In one embodiment, processor 40 can comprise a first applications microprocessor configured to run a variety of personal information management applications, such as email, a calendar, contacts, etc., and a second, radio processor on a separate chip or as part of a dual-core chip with the application processor. The radio processor is configured to operate telephony functionality.

Device 10 comprises a receiver 38 which comprises analog and/or digital electrical components configured to receive and transmit wireless signals via antenna 22 to provide cellular telephone and/or data communications with a fixed wireless access point, such as a cellular telephone tower, in conjunction with a network carrier, such as, Verizon Wireless, Sprint, etc. Device 10 can further comprise circuitry to provide communication over a local area network, such as Ethernet or according to an IEEE 802.11x standard or a personal area network, such as a Bluetooth or infrared communication technology.

Device 10 further comprises a microphone 36 (see FIG. 2) configured to receive audio signals, such as voice signals, from a user or other person in the vicinity of device 10, typically by way of spoken words. Alternatively or in addition, processor 40 can further be configured to provide video conferencing capabilities by displaying on display 18 video from a remote participant to a video conference, by providing a video camera on device 10 for providing images to the remote participant, by providing text messaging, two-way audio streaming in full- and/or half-duplex mode, etc.

Device 10 further comprises a location determining application, shown in FIG. 3 as GPS application 44. GPS application 44 can communicate with and provide the location of device 10 at any given time. Device 10 may employ one or more location determination techniques including, for example, Global Positioning System (GPS) techniques, Cell Global Identity (CGI) techniques, CGI including timing advance (TA) techniques, Enhanced Forward Link Trilateration (EFLT) techniques, Time Difference of Arrival (TDOA) techniques, Angle of Arrival (AOA) techniques, Advanced Forward Link Trilateration (AFTL) techniques, Observed Time Difference of Arrival (OTDOA), Enhanced Observed Time Difference (EOTD) techniques, Assisted GPS (AGPS) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), and so forth.

Device 10 may be arranged to operate in one or more location determination modes including, for example, a standalone mode, a mobile station (MS) assisted mode, and/or an MS-based mode. In a standalone mode, such as a standalone GPS mode, device 10 may be arranged to autonomously determine its location without real-time network interaction or support. When operating in an MS-assisted mode or an MS-based mode, however, device 10 may be arranged to communicate over a radio access network (e.g., UMTS radio access network) with a location determination entity such as a location proxy server (LPS) and/or a mobile positioning center (MPC).

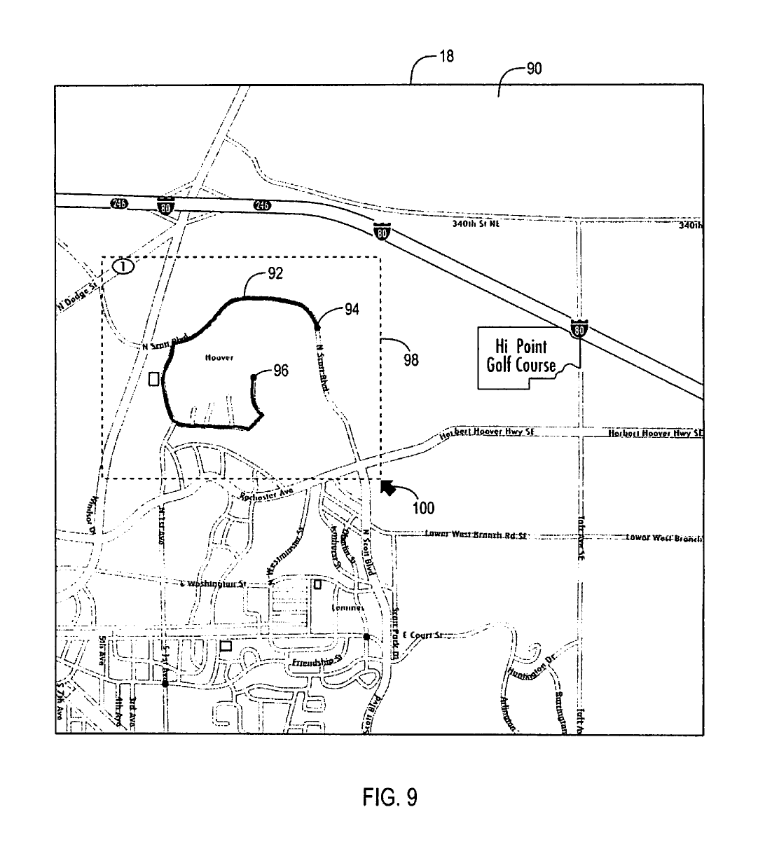

Referring now to FIGS. 6-10, users may wish to be able to capture visual data (e.g., “mobile access information” or “mobile access data” such as data the user can see either by way of a display, a camera application, etc.) and make the captured data easily accessible for future reference. For example, referring to FIG. 9, a user may be using a mapping application such as Google Maps that provides a map 90 having detailed driving directions from a first point 94 (a starting or beginning location) to a second point 96 (e.g., a destination or ending location) through a particular geographic area and/or along a specific route 92. If the user is familiar with the area, the user may need only know the intersection of streets at the destination location to be able to find the destination location. In such a situation, the user may wish to save only a portion 98 of screen data having the desired intersection or route information (e.g., a “snapshot” or image of a particular area, etc.) and be able to quickly retrieve the image (e.g., via a mobile device) while en route to the destination location. For example, as shown in FIG. 9, a user may manipulate a cursor 100 to identify a portion 98 of map 90 to be saved for later reference. Various features of the embodiments disclosed herein may facilitate this process.

Various embodiments disclosed herein generally relate to capturing visual data (e.g., data displayed on a display screen, data viewed while using a camera I camera application, etc.), storing the data, and providing an easy and intuitive way for users to retrieve and/or process the data via either a desktop computer, mobile computer, or other computing device (e.g., by way of an “electronic corkboard,” a “card deck,” or similar retrieval system). The captured data (e.g., “mobile access information,” “mobile access data,” etc.) may be data the user is able to see (e.g., via a display, camera, etc.), and/or data where it is likely the user may need or wish to view the data at a later time (e.g., directions, a map, a recipe, instructions, a name, etc.). However, the user may not want to permanently store the data or have to re-open an application such as a mapping program, etc., at a later date in order to access the data. As such, mobile access information may be information for which the user typically only need to view a “snapshot” of visual data, such as an intersection on a map, a recipe, information related to a parking spot in a parking structure, etc.

Referring to FIG. 6, device 10 is shown as part of a communication network or system according to an exemplary embodiment. As shown in FIG. 6, device 10 may be in communication with a desktop or other computing device 50 (e.g., a desktop PC, a laptop computer, etc.) and/or one or more servers 54 via a network 52 (e.g., a wired or wireless network, the Internet, an intranet, etc.). For example, in some embodiments computing device 50 may be a user's office computer (e.g., a desktop or laptop computer) and device 10 may be a smartphone, PDA, or other mobile computing device the user typically carries while away from the office computer. In some embodiments, devices 10 and 50 may communicate or transfer data directly (e.g., via Bluetooth, Wi-fi, or any other appropriate wired or wireless communications). In other embodiments, devices 10 and 50 may communicate or transfer data via server 54 (e.g., such that device 50 transmits data to server 54, and device 10 queries server 54 to transmit any data received from device 50 to device 10, etc.).

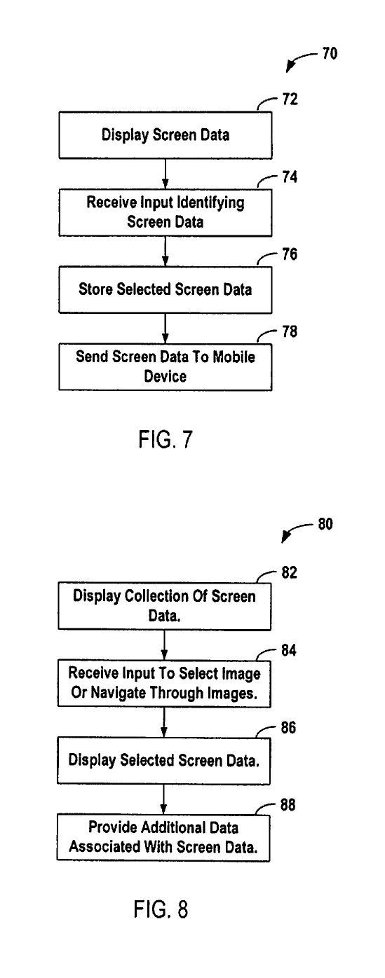

Referring to FIG. 7, a method 70 of capturing visual data utilizing one or more computing devices is shown according to an exemplary embodiment. According to one embodiment, device 10 and/or computing device 50 may be configured to provide a display of data or information (e.g., display or screen data, image data, an image through a camera application, etc.) to a user (step 72). Screen data may include images (e.g., people, places, etc.), messaging data (e.g., emails, text messages, etc.), pictures, word processing documents, spreadsheets, camera views, or any other type of data (e.g., bar codes, business cards, etc.) that may be displayed via a display and/or viewable by a user of device 10 and/or device 50.

Device 10 and/or computing device 50 may be configured to enable a user to select all or a portion of screen data provided on a display (step 74). In some embodiments, a designated “hot key” or “hot button” may be preprogrammed to enable a user to capture all of the displayed data or information. Alternatively, a user may use a mouse, touchscreen (e.g., utilizing one or more fingers, a stylus, etc.), input buttons, or other input device to identify a portion of the information or data being displayed. It should be noted that images may be captured via device 10 in a variety of ways, including via a camera application, by user interaction with a touchscreen, by download from a remote source such as a remote server or another mobile computing device, etc.

In response to a user identifying all or a portion of data or information to be captured, device 10 and/or device 50 stores the data (e.g., as an image file such as JPEG, JIFF, PNG, etc.) (step 76). In some embodiments, the captured data is stored as an image file regardless of the type of underlying data displayed (e.g., image files, messaging data such as emails, text messages, etc., word processing documents, spreadsheets, etc.). According to other embodiments, the data may be stored using other file types. Multiple image files may be stored in a single location (e.g., a “mobile access folder,” an “electronic corkboard,” etc.), that may be represented, for example, by an icon or other visual indicator on a user's main screen or other screen display (e.g., a “desktop,” a “today” screen, etc.).

In some embodiments, in response to a user saving an image (e.g., on a desktop PC such as device 50), the image is automatically (e.g., in response to or based on saving and/or capturing the image, without requiring input from a user, etc.) transmitted for downloading to a second device or other remote location (e.g., a mobile device such as device 10, a server such as server 54, etc.) (step 78). For example, in one embodiment, images may be transmitted (e.g., via Bluetooth, Wi-Fi, or other wireless or wired connection) from device 50 to device 10 immediately, or immediately upon saving. Alternatively, device 50 may transmit the image to a server such as server 54, such that device 10 may query server 54 to request that the image(s) be transmitted from server 54 to device 10. In the case where an image is captured using device 10, further transfer of the data may not be necessary as the data is already on the user's mobile device. In other embodiments, device 10 may transmit (either automatically or in response to a user input) an image to device 50, server 54, or another remote device after capturing the image.

According to one embodiment, in addition to capturing and saving screen images as image files, other data may be stored, or other types of data storage may be utilized. For example, in one embodiment, one or more links to the original data (e.g., a web page, an email, word processing document, etc.) may be generated and saved in order to enable a user to access the original data if desired. Device 10 and/or device 50 may further be configured to store metadata associated with image files, such as data type, text columns, graphic images or regions, and the like, for later use by device 10 and/or device 50.

Referring now to FIG. 8, a method 80 of viewing and retrieving stored data is shown according to an exemplary embodiment. In one embodiment, device 10 and/or device 50 may be configured to receive an input from a user to display various image files such as one or more image files saved in connection with the embodiment discussed in connection with FIG. 7. For example, device 10 may be configured to display an icon or other type of selectable image that represents a collection of image files. In response to receiving the input, device 10 may display one or more previously saved images (e.g., screen shots, photographs, etc.) (step 82).

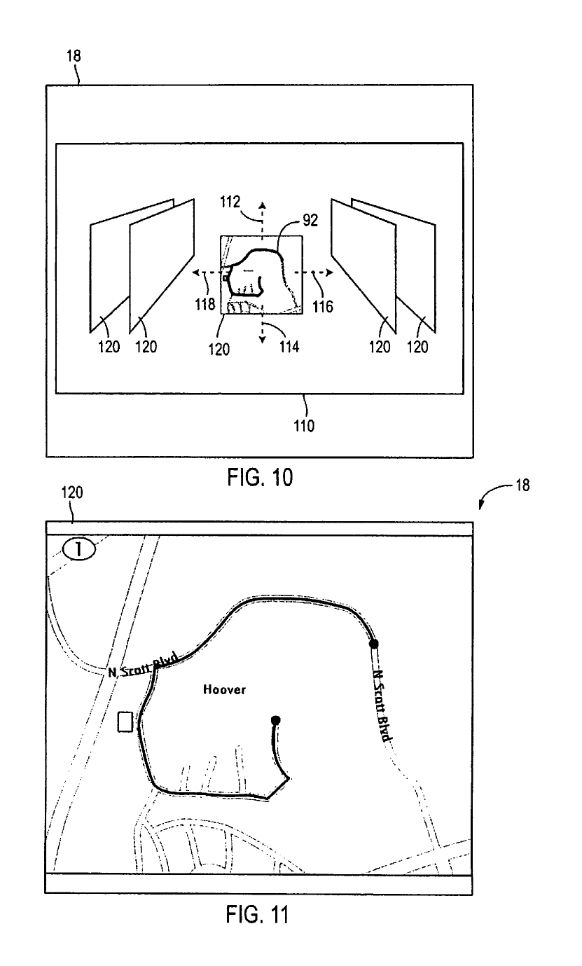

Referring to FIG. 10, in one embodiment, the image files may be represented by a number of images 120 (e.g., “cards,” pictures, graphical representations of the image files, etc.) that are arranged across a display screen such as display 18 on device 10. Device 10 may arrange images in chronological order based on when the underlying image files were created (e.g., such that the images are arranged newest to oldest along the screen either left-to-right, right-to-left, up-down, etc.). According to various other embodiments, device 10 may sort images 120 according to various other factors, including the location of the user/device when the image was captured, the type of underlying data, a user-defined sorting arrangement, etc.

Referring further to FIGS. 8 and 10, device 10 may enable a user to quickly browse or navigate through images 120 and select one or more images (step 84). For example, as shown in FIG. 10, device 10 maybe configured to provide a collection 110 of images 120 on display 18. In one embodiment, display 18 may be a touch screen display such that a user may browse through and select one or more images 120 by using various “swipes,” “taps” and/or similar finger gestures. For example, in one embodiment, images 120 may be arranged as shown in FIG. 10 (i.e., in a left-to-right manner). In order to browse through the images, the user may swipe a finger across display 18 (e.g., along arrow 116 and/or arrow 118), in response to which images 120 will move across the screen accordingly (e.g., either to the left or right depending on the direction of the swipe).

Referring further to FIG. 10, device 10 may be configured to delete images from collection 110. According to one embodiment, device 10 may delete images after a certain time period (e.g., 1 week, 1 month, a user-defined time period, etc.). According to another embodiment, images may be deleted in response to various user inputs. For example, a center image 120 may be deleted by selecting a certain button or key, by depressing a specific icon on a touchscreen display, etc. According to further embodiments, a swipe gesture (e.g., an upward or downward swipe along one of arrows 112 and 114 shown in FIG. 10) may be used to delete an image such as image 120. Providing various options to delete images facilitates minimizing “clutter” of image collection 110.

In one embodiment, images 120 may be thumb-nail sized images representing larger images, such that upon receiving a selection of one of images 120 (e.g., via a tap, input key, etc.), a full-sized image is displayed (step 86) (see FIG. 11). As mentioned earlier, one or more links to the underlying data (e.g., a web page, a document, etc.) may be provided by device 10 and be selectable by a user to return to the original underlying data (step 88). Further yet, device 10 may provide scrolling and zooming features that enable a user to navigate about an individual image 120. In some embodiments, “smart software” (e.g., smart-zooming/snapping may be used to define different areas of image 120 and to snap to appropriate sections. For example, images may be analyzed to identify printable (e.g., characters, borders, etc.) or non-printable (e.g., HTML <div> tags that define a portion of an HTML document, cascading style sheet (CSS) settings, etc.) objects; determine the boundaries of objects (e.g., one or more edges of an image, etc.); recognize content (e.g., natural language content, image content, facial recognition, object recognition (e.g., background/foreground etc.); and/or differentiate content (e.g., based on font size, etc.).

It should be noted that the various embodiments discussed herein provide many benefits to users. For example, one or more of the features described herein may be implemented as part of a desktop application that permits easy capture of data/information and transfer of the data/information to a mobile device. Metadata may also be stored that may identify the type or source of the underlying data and/or enable an image to be converted back to the original data type. Metadata may also enable smart zooming/snapping to appropriate areas of images. Furthermore, saved images can be easily browsed by way of a user interface that utilizes fast image searching/retrieval/deletion features. Further yet, according to various exemplary embodiments, device 10 may provide data in a “context aware” fashion such that images may be based on contextual factors such as time of day, day of year, location of the user and so on (e.g., such that “map” images are displayed first when a user is located with his or her car, etc.). Additionally, users may set up one or more accounts (e.g., password-protected accounts) and users may direct images to specific accounts (e.g., for uploading).

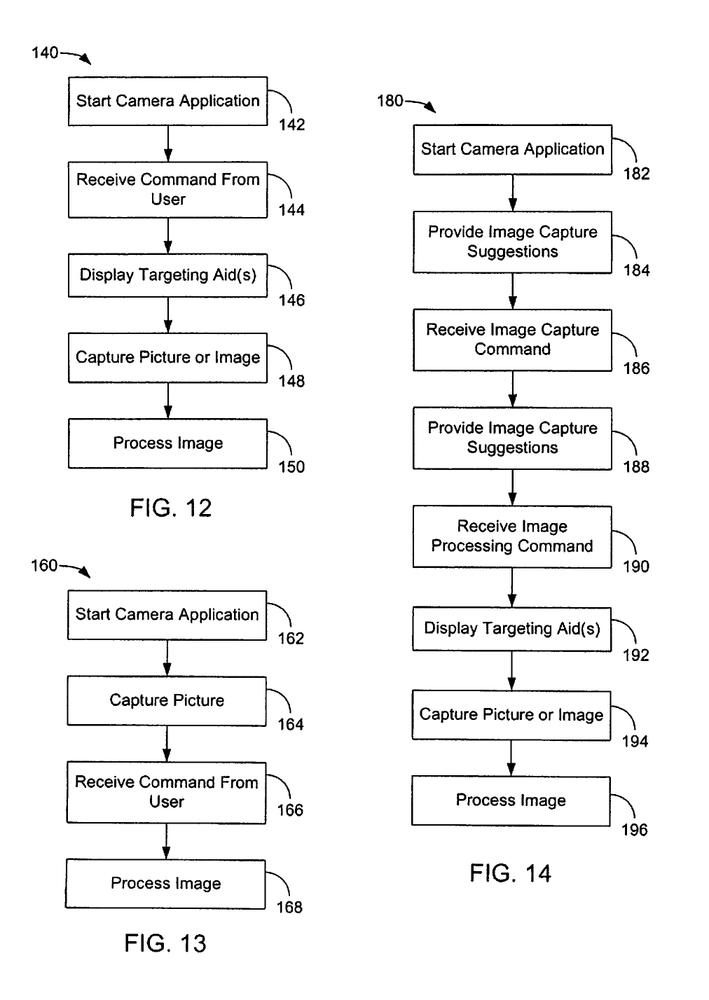

As discussed above, various types of data from various data sources may be captured utilizing techniques described in one or more of the various embodiments described herein. Referring to FIGS. 12-14, various exemplary embodiments are provided relating to utilizing a camera such as camera 28 (see FIG. 3) provided as part of device 10 to capture data, which may include “mobile access data” or information as described above. The embodiments discussed herein may facilitate the tasks of providing image capture commands (e.g., a pre-capture command, etc.) and image processing commands (e.g., a post-capture command, an “action” command, etc.), and may in turn streamline the process of capturing and processing pictures captured utilizing device 10. Pre-capture commands or image capture commands may generally be associated with camera settings or parameters that are set or determined prior to capturing an image (e.g., whether to use landscape or portrait orientation, whether to use one or more targeting or focusing aids, etc.). Post-capture commands, image processing commands, and/or action commands may generally be associated with “actions” that are to be taken by device 10 after capturing an image (e.g., whether to apply a recognition technology such as text recognition, facial recognition, etc.).

In some embodiments, a single application (e.g., a camera application) running on processing circuit 46 of device 10 may enable a user to provide both image capture commands and image processing commands either pre or post capture (e.g., one or both of the image capture command(s) and the image processing command(s) may be received prior to a user taking a picture with device 10). Consolidating these functions into a single application may minimize the number of inputs that are required to direct device 10 to properly capture an image and later process and take action regarding the image, such as uploading the image to a remote site, utilizing one or more recognition technologies (e.g., bar code recognition, facial recognition, text I optical character recognition (OCR), image recognition, facial recognition, and the like), and so on.

According to various exemplary embodiments, a number of different recognition technologies may be utilized by device 10, both to receive and execute commands provided by users. For example, device 10 may utilize voice recognition technology to receive image capture and/or image processing commands from a user. Any suitable voice recognition technology known to those skilled in the art may be utilized. According to alternative embodiments, device 10 may be configured to display a menu of command options (e.g., image capture command options, image processing command options, etc.) to a user, and the user may be able to select one or more options utilizing an input device such as a touchscreen, keyboard, or the like. Other means of receiving commands from users may be used according to various other exemplary embodiments.

According to various exemplary embodiments, a number of different image capture commands may be received by device 10. For example, the image capture commands may include a “business card” command, which may indicate to device 10 that a user is going to take a photograph of a business card. Another command may be a “barcode” command, which indicates to device 10 that a user is going to take a photograph of a barcode (e.g., a Universal Product Code (UPC) symbol, barcodes associated with product prices, product reviews, books, DVDs. CDs, catalog items, etc.). A wide variety of other image capture commands may be provided by users and received by device 10, including a “macro” command (indicating that a close-up photograph will be taken). Other image capture commands may be utilized according to various other embodiments, and the present application is not limited to those commands discussed herein.

Similarly, according to various exemplary embodiments, a number of different image processing commands may be received by device 10. For example, the image processing commands may include a “translate” command, which may indicate to device 10 that a user wishes for a portion of text (e.g., a document, web page, email, etc.) to be translated (e.g., into a specified language such as English, etc.). Another image processing command may be an “Upload” command, which may indicate to device 10 that the user wishes to upload the picture to a website, etc. (e.g., Flickr, facebook, yelp, etc.). A wide variety of other image processing commands may be provided by users and received by device 10, including a “restaurant” command (e.g., to recognize the logo or name of a restaurant and display a search option, a restaurant home page, a map, etc.); a “guide” command (e.g., to recognize a landmark and display tourist information such as a tour guide, etc.); a “people”/“person” command (e.g., to utilize facial recognition to identify a person and cross-reference a contacts directory on device 10, a web-based database, etc.); a “safe” or “wallet” command (e.g., to encrypt an image and/or limit access using a password, etc.); a “document” command (e.g., to utilize text recognition etc.); a “scan” command (e.g., to convert an image to a PDF file, etc.); a “search” command (e.g., to utilize text recognition and subsequently perform a search (e.g., a global search, web- based search, etc.) based on identified text, etc.), and the like. Other image processing commands may be utilized according to various other embodiments, and the present application is not limited to those commands discussed herein. Each image processing command directs device 10 to take particular action(s) (i.e., “process”) captured images.

In some embodiments, image capture commands may be definable by a user of device 10, such that a user may define various parameters of a camera application (e.g., data type, desired targeting aids, orientation, etc.) and associate the parameters with a particular image capture command. Similarly, device 10 may be configured to enable users to define image processing commands. For example, device 10 may enable a user to configure a “contacts” command that directs processing circuit 46 to upload data (e.g., name, address, phone, email, etc.) captured from a business card to a contacts application running on device 10. Furthermore, the image processing commands and image capture commands may be combined into a single command, such as a single word or phrase to be voiced by a user (e.g., such that the phrase “business card” acts to instruct device 10 to provide a proper targeting aid for a business card, capture the text on the business card, and save the contact information to a contacts application).

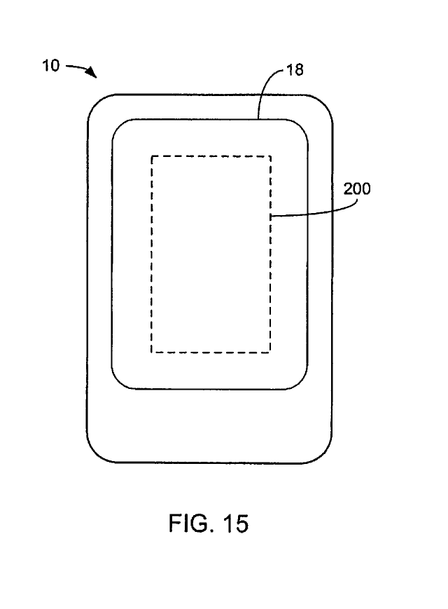

Referring to FIG. 12, a method 140 of capturing and processing a photograph is shown according to an exemplary embodiment. First, device 10 launches a camera application on device 10 (step 142), for example, in response to a user selecting a camera application icon displayed on display 18 of device 10. Next device 10 receives a pre-image capture command from a user (e.g., an image capture command, etc.) (step 144). In one embodiment, device 10 receives a voice command from a user and utilizes voice recognition technology or a similar technology to derive an appropriate image capture command from the voice command. Next, one or more targeting aids or other features (e.g., picture-taking aids, suggestions, hints, etc.) may be provided to a user (step 146). For example, referring to FIG. 15, a targeting aid 200 may provide an outline (e.g., a dashed line provided on a display screen, etc.) corresponding to the periphery of a traditional business card to help the user focus a camera on a business card to be photographed. Device 10 may then take the photograph (step 148) to capture a desired image in response to a user input (e.g., a button press, a voice input, etc.). Next, device 10 may process the image or photograph based on one or more image processing commands (e.g., upload the image to a website, save the image in a specific folder, apply one or more recognition technologies to the image, and so on).

According to one embodiment, a command such as “corkboard” may be used to indicate that a captured image should be saved in accordance with the features described in the various embodiments of FIGS. 6-11 (e.g., such that after taking a picture device 10 may automatically store the image as part of collection 110, forward the image to device 50 and/or server 54, etc.).

Referring now to FIG. 13, a method of capturing and processing a photograph or image is shown according to an exemplary embodiment. First, device 10 launches a camera application on device 10 (step 162), for example, in response to a user selecting a camera application icon displayed on display 18 of device 10. Device 10 may then take the photograph (step 164) to capture a desired image in response to a user input (e.g., a button press, a voice input, etc.). The image may be captured with or without receiving a pre-capture command from a user, as described with respect to FIG. 12. Device 10 then receives an image processing command from a user (step 166) and processes the image based on the image processing command(s) (step 168) (e.g., upload the image to a website, save the image in a specific folder, apply one or more recognition technologies to the image, and so on).

Referring now to FIG. 14, a method 180 of capturing and processing a photograph or image is shown according to an exemplary embodiment. First, device 10 launches a camera application on device 10 (step 182), for example, in response to a user selecting a camera application icon displayed on display 18 of device 10. Next, device 10 may provide image capture command suggestions or options to a user (step 184), for example, by way of a menu of selectable options provided on display 18. The options may represent image capture commands that device 10 determines are most likely to be utilized according to various criteria.

In one embodiment, processing circuit 46 may be configured to predict or determine the image capture options based on a user's past picture-taking behavior (e.g., by tracking the types of pictures the user takes most often, such as pictures of people, bar codes, business cards, etc., the camera settings utilized by a user, location of the user, and so on). Alternatively, processing circuit 46 may utilize one or more recognition technologies to process a current image being viewed via camera 28 and predict what image capture commands may be most appropriate. For example, processing circuit 46 may determine that the current image is of a text document, and that a text recognition mode may be most appropriate. Device 10 may then suggest a text recognition command to the user. In yet another embodiment, device 10 may be configured to receive user preferences that define what image capture commands should be provided. For example, a user may specify that he or she always wants a “people” command, a “business card” command, and a “text” command displayed.

Referring further to FIG. 14, device 10 receives the image capture command from the user (step 186). Next, device 10 may provide image processing command suggestions to a user (step 188), for example, by way of a menu of selectable options provided on display 18. Image processing command suggestions may be determined in a similar fashion to the image capture command suggestions discussed with respect to step 184. Next, device 10 receives the image processing command (step 190). Device 10 may then display any targeting or other aids (step 192) and take the photograph (step 194) to capture the image. Device 10 then processes the image (step 196) according to the one or more image processing commands received as part of step 190.

It should be noted that the various embodiments disclosed herein may be utilized alone, or in any combination, to suit a particular application. For example, the various features described with respect to capturing and processing photographs or images in FIGS. 12-15 may be utilized as part of the data capture/storage/retrieval features in FIGS. 6-11. Various other modifications may be used according to other embodiments.

Various embodiments disclosed herein may include or be implemented in connection with computer-readable media configured to store machine-executable instructions therein, and/or one or more modules, circuits, units, or other elements that may comprise analog and/or digital circuit components configured or arranged to perform one or more of the steps recited herein. By way of example, computer-readable media may include RAM, ROM, CD-ROM, or other optical disk storage, magnetic disk storage, or any other medium capable of storing and providing access to desired machine-executable instructions.

While the detailed drawings, specific examples and particular formulations given describe exemplary embodiments, they serve the purpose of illustration only. The hardware and software configurations shown and described may differ depending on the chosen performance characteristics and physical characteristics of the computing devices. The systems shown and described are not limited to the precise details and conditions disclosed. Furthermore, other substitutions, modifications, changes, and omissions may be made in the design, operating conditions, and arrangement of the exemplary embodiments without departing from the scope of the present disclosure as expressed in the appended claims.

What is claimed is:

1. A method of using a wireless handheld device:
starting a camera application of the handheld device, which operates a camera of the handheld device;
displaying screen data on a touch screen of the handheld device, wherein the screen data comprises:
a camera view of a current image via the camera of the handheld device, and
graphic images;
determining a location of the handheld device;
based at least on the current image of the camera view and the location of the handheld device, predicting one or more image capture command;
displaying the predicted one or more image capture command on the touch screen;
after displaying the predicted one or more image capture command, receiving first user input selecting a desired image capture command from one of the predicted one or more image capture command;
after receiving the first user input selecting the desired user capture command, displaying a target aid on a portion the screen data;
after displaying the target aid, receiving a second user input that directs the handheld device to perform the desired image capture command; and
processing the screen data in accordance with the desired image capture command.

2. The method of claim 1 wherein the first user input is received via the touch screen.

3. The method of claim 1 wherein the first user input is received via a voice command.

4. The method of claim 1 wherein the second user input is received via the touch screen.

5. The method of claim 1 wherein the second user input is received via a voice command.

6. The method of claim 1 wherein the target aid provides an outline of an item in the screen data displayed on the touch screen.

7. The method of claim 1 wherein the processing the screen data comprises at least one of:
performing facial recognition;
image recognition; and
optical character recognition.

8. The method of claim 1 wherein the processing the screen data comprises translating text within the screen data.

9. The method of claim 1 wherein the processing the screen data comprises automatically uploading a picture to a social media site.

10. A wireless handheld device comprising:
a camera operable to provide a camera view of a current image;
a touch screen operable to receive user input and display screen data, wherein the screen data comprise:
the camera view of the current image, and
graphic images;
a processor operable to:
start a camera application, which controls the camera,
direct the touch screen to display the screen data,
determine a location of the handheld device,
based at least on the current image of the camera view and the location of the handheld device, predict one or more image capture command, and
direct the touch screen display to display the predicted one or more image capture command on the touch screen,
wherein after the predicted one or more image capture command is displayed, the touch screen is operable to receive first user input selecting a desired image capture command from one of the predicted one or more image capture command,
wherein after receiving the first user input selecting the desired user capture command, the touch screen is operable to display a target aid on a portion the screen data,
wherein after displaying the target aid, the touch screen is operable to receive a second user input that directs the processor to perform the desired image capture command, and
wherein in response to the second user input, the processor is operable to process the screen data in accordance with the desired image capture command.

11. The device of claim 10 wherein the target aid provides an outline of an item in the screen data displayed on the touch screen.

12. The device of claim 10 wherein the processor processes the screen data by performing at least one of facial recognition, image recognition, and optical character recognition.

13. The device of claim 10 wherein the processor processes the screen data at least by translating text within the screen data.

14. The device of claim 10 wherein the processor processes the screen data at least by automatically uploading a picture to a social media site.

15. A non-transitory computer-readable medium having program code recorded thereon, which causes a wireless handheld device to process screen data, the program code comprising:
code for starting a camera application of the handheld device, which operates a camera of the handheld device;
code for displaying screen data on a touch screen of the handheld device, wherein the screen data comprises:
a camera view of a current image via the camera of the handheld device, and
graphic images;
code for determining a location of the handheld device;
based at least on the current image of the camera view and the location of the handheld device, code for predicting one or more image capture command;
code for displaying the predicted one or more image capture command on the touch screen;
after displaying the predicted one or more image capture command, code for receiving first user input selecting a desired image capture command from one of the predicted one or more image capture command;
after receiving the first user input selecting the desired user capture command, code for displaying a target aid on a portion the screen data;
after displaying the target aid, code for receiving a second user input that directs the handheld device to perform the desired image capture command; and
code for processing the screen data in accordance with the desired image capture command.

16. The non-transitory computer-readable medium of claim 15 wherein the first user input is received via the touch screen.

17. The non-transitory computer-readable medium of claim 15 wherein the first user input is received via a voice command.

18. The non-transitory computer-readable medium of claim 15 wherein the second user input is received via the touch screen.

19. The non-transitory computer-readable medium of claim 15 wherein the second user input is received via a voice command.

20. The non-transitory computer-readable medium of claim 15 wherein the target aid provides an outline of an item in the screen data displayed on the touch screen.

21. The non-transitory computer-readable medium of claim 15 wherein the code for processing the screen data comprises at least one of:
code for performing facial recognition;
code for image recognition; and
code for optical character recognition.

22. The non-transitory computer-readable medium of claim 15 wherein the processing the screen data comprises translating text within the screen data.

23. The non-transitory computer-readable medium of claim 15 wherein the processing the screen data comprises automatically uploading a picture to a social media site.

24. A wireless handheld device:
means for starting a camera application of the handheld device, which operates a camera of the handheld device;
means for displaying screen data on a touch screen of the handheld device, wherein the screen data comprises:
a camera view of a current image via the camera of the device, and graphic images;
means for determining a location of the handheld device;
based at least on the current image of the camera view and the location of the handheld device, means for predicting one or more image capture command;
means for displaying the predicted one or more image capture command on the touch screen;
after displaying the predicted one or more image capture command, means for receiving first user input selecting a desired image capture command from one of the predicted one or more image capture command;
after receiving the first user input selecting the desired user capture command, means for displaying a target aid on a portion the screen data;
after displaying the target aid, means for receiving a second user input that directs the handheld device to perform the desired image capture command; and
means for processing the screen data in accordance with the desired image capture command.

25. The handheld device of claim 24 wherein the first user input is received via the touch screen.

26. The handheld device of claim 24 wherein the first user input is received via a voice command.

27. The handheld device of claim 24 wherein the second user input is received via at least one of: a voice command and the touch screen.

28. The handheld device of claim 24 wherein the target aid provides an outline of an item in the screen data displayed on the touch screen.

29. The handheld device of claim 24 wherein the processing the screen data comprises at least one of:
means for performing facial recognition;
means for image recognition; and
means for optical character recognition.

30. The handheld device of claim 24 wherein the processing the screen data comprises translating text within the screen data.
